(19) United States
(12) Patent Application Publication
(10) Pub. No.: US 2015/0149798 A1
(43) Pub. Date: May 28, 2015

(54) INFORMATION PROCESSING DEVICE

(71) Applicant: Sony Computer Entertainment Inc., Tokyo (JP)

(72) Inventor: Shigeru Enomoto, Kanagawa (JP)

(21) Appl. No.: 14/405,244

(22) PCT Filed: Apr. 16, 2013
(86) PCT No.: PCT/JP2013/002574

§ 371 Date: Dec. 3, 2014

(30) Foreign Application Priority Data
Jun. 12, 2012 (JP) 2012-133227

(51) Int. Cl. G06F 1/32

(52) U.S. Cl. CPC G06F 1/3206; G06F 1/3293
USPC 713/320

(57) ABSTRACT

In an information processing device 10, while a main CPU 200 is in a standby state, a sub CPU 100 is in an active state. While the sub CPU 100 is in the standby state, the main CPU 200 is in the active state. The main CPU 200 and the sub CPU 100 are capable of reading data from a storage device. Upon receipt of a power ON instruction by a button monitoring unit 70, the sub CPU 100 starts the main CPU 200 and goes into the standby state, and upon receipt of a power OFF instruction by the button monitoring unit 70, the main CPU 200 starts the sub CPU 100 and goes into the standby state.

### TECHNICAL FIELD

The present invention relates to an information processing device such as a game machine.

### BACKGROUND ART

In the past, game software was distributed and marketed using ROM media such as optical discs, magneto-optical discs and Blu-ray discs. In recent years, however, it has been general practice to resort to a mode of distribution in which the software is downloaded from content servers connected to the Internet. Patent Literature 1 discloses a game machine having a download module of which the start date and time is set by a user to let a system controller turn on the main power supply of an information processing device at the set start date and time, so that the information processing device starts the download module to perform download.

### CITATION LIST

### Patent Literature

[PTL 1] U.S. Published Application No. 2011/0307583

### SUMMARY

### Technical Problem

As the network environment has been improved to let game machines connect continuously to the Internet, systems have been devised in which an information providing request sent by a server to game machines causes the game machines to collect information about their users' activities and about the content installed in an auxiliary storage device of each game machine and transmit the collected information to the server. In such a system, it is preferable for the server to collect the latest information at a desired timing.

However, with the information processing devices such as one disclosed in the above-cited Patent Literature 1, a main controller of the device is in standby mode and inactive so that the server cannot transmit the information providing request to that device. With the server required to transmit the information providing request only to the information processing devices in active mode, it may be difficult to obtain appropriate statistics because the demographics of the users (age, gender, profession, etc.) can be biased depending on the hour at which the request is transmitted. In a system in which the game machines are connected to the server via a network, it is thus preferable for the game machines to respond instantaneously to the request from the server. Also, not just for the game system but also for other information processing environments, it has been desired to develop techniques for responding immediately to requests from the server and for acquiring information instantaneously from the server.

It is therefore an object of the present invention to provide techniques for communicating efficiently with an external server and another information processing device.

### Solution to Problem

In solving the problems above and according to one embodiment of the present invention, there is provided an information processing device which is connected to or incorporates a storage device and which includes a main CPU and a sub CPU. While the main CPU is in a standby state, the sub CPU is placed in an active state.

According to another embodiment of the present invention, there is also provided an information processing device which is connected to or incorporates a storage device and which includes a main CPU and a sub CPU. Either the main CPU or the sub CPU alone is placed in an active state.

Incidentally, if other combinations of the above-outlined composing elements or the above expressions of the present invention are converted between different forms such as a method, a device, a system, a storage medium, and a computer program, they still constitute effective embodiments of this invention.

### BRIEF DESCRIPTION OF DRAWINGS

FIG. 1 is a diagram showing an information processing system as an embodiment of the present invention.

FIG. 2 is a functional block diagram of an information processing device.

FIG. 3 is a functional block diagram of the information processing device, depicting the relations between a subsystem and a main system of this embodiment.

### DESCRIPTION OF EMBODIMENT

Prior to a specific explanation of the embodiment of the present invention, the present invention is described below in broad outline. The information processing device of this embodiment includes a main system having a main CPU (Central Processing Unit) and a subsystem having a sub CPU. The main CPU and the sub CPU operate in a manner mutually exclusive to each other. That is, when the main CPU is started and in an active state, the sub CPU is in a standby state; when the sub CPU is started and in the active state, the main CPU is in the standby state. While the main power supply of the information processing device remains on, the main CPU is in the active state and carries out various processes whereas the sub CPU is in sleep mode. While the main power supply of the information processing device remains off, the main CPU starts the sub CPU and goes into sleep mode. In this manner, the main CPU and the sub CPU operate in a mutually exclusive manner.

The main CPU has a function of executing game programs that may be installed in an auxiliary storage device, whereas the sub CPU has no such function. However, the sub CPU of this embodiment can access the auxiliary storage device. The sub CPU has an information providing function and a download processing function, the information providing function being one which, upon receipt of an information providing request from a network server, accesses the auxiliary storage device for requested information and transmits the relevant information to the network server. The download processing function of the sub CPU involves downloading content files from a content server and storing the downloaded files into the auxiliary storage device. The sub CPU is configured to have only these limited processing functions and thus can operate with less power consumption than the main CPU. The main CPU also has the information providing function and download processing function allotted to the sub CPU, so that the main CPU may carry out an information providing process or a download process while the sub CPU is in sleep mode.

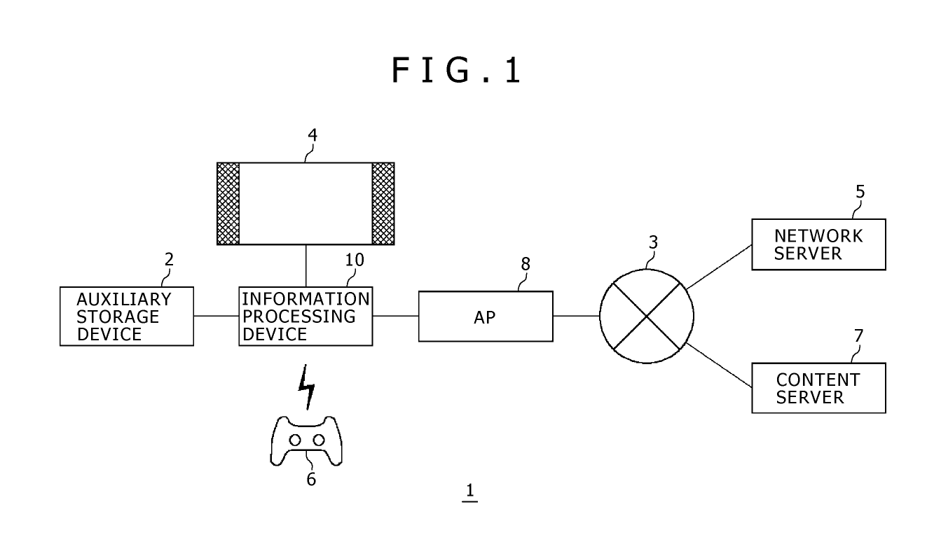

FIG. 1 shows an information processing system 1 as one embodiment of the present invention. The information processing system 1 includes an information processing device 10 as a user terminal, a network server 5, and a content server 7. An auxiliary storage device 2 is a large-capacity storage device such as an HDD (Hard Disk Drive) or a flash memory and is connected to, or incorporated in, the information processing device 10. The auxiliary storage device 2 may alternatively be an external storage device connected to the information processing device 10 via a USB (Universal Serial Bus), or a built-in storage device. An output device 4 may be a TV set that has a display for video output and speakers for audio output, or a computer display. The output device 4 may be connected to the information processing device 10 with a cable or via a wireless LAN. Connected with the output device 4, the information processing device 10 outputs the result of its processing thereto. The information processing device 10 is connected in wireless or wired fashion to an input device 6 operated by a user, and receives operation signals from the input device 6. The information processing device 10 may be a game machine. In this case, the input device 6 is a game controller.

An access point (called the AP hereunder) 8 has the functions of a wireless access point and a router. The information processing device 10 connects to the AP 8 in wireless or wired fashion so as to connect communicably with the network server 5 and content server 7 on a network 3.

The network server 5 transmits the information providing request to the information processing device 10 in the form of a script, for example. In the information processing device 10, either the main CPU or the sub CPU capable of processing the script remains active. Thus, the network server 5 can transmit the information providing request to any information processing device 10 regardless of its main power supply being turned on or off.

The content server 7 transmits content files to the information processing device 10 on a push basis. In the information processing device 10, either the main CPU or the sub CPU capable of downloading content files remains active. Thus, the content server 7 can distribute the content files to any information processing device 10 regardless of its main power supply being turned on or off. The content server 7 may be composed of a single or multiple servers. For example, the content files to be distributed may be system software for update or patch files to be applied to currently installed applications. As another alternative, the content files may be those constituting a demo game or a game trailer recommended by the content server 7.

In the network server 5, the account ID of the user who uses each information processing system 1 (called the “user account” hereunder) is registered. When the main power supply of the information processing device 10 remains on and the user logs in to the information processing device 10 with his user account, the main CPU of the information processing device 10 transmits authentication information (user account and password) to the network server 5. When the network server 5 certifies the authentication information as correct, the user can sign in to the services offered by the network server 5 or by the content server 7. Incidentally, the information processing device 10 of this embodiment can be used simultaneously by multiple users; each of the users can sign in to the service offerings with his user account.

Even after the main power supply of the information processing device 10 is turned off, the sub CPU of the information processing device 10 maintains the connection with the network server 5 or with the content server 7 using the user account of at least one user registered with the information processing device 10. For example, when the main power supply is turned on, the user account of the user who signed in last may be used to maintain the connection with each server in effect after the main power supply was turned off. The network server 5 manages the registered user accounts per information processing device 10. Thus, where multiple user accounts are registered with a given information processing device 10, the network server 5 registers the identification information (console ID) of that information processing device 10 in association with its multiple user accounts.

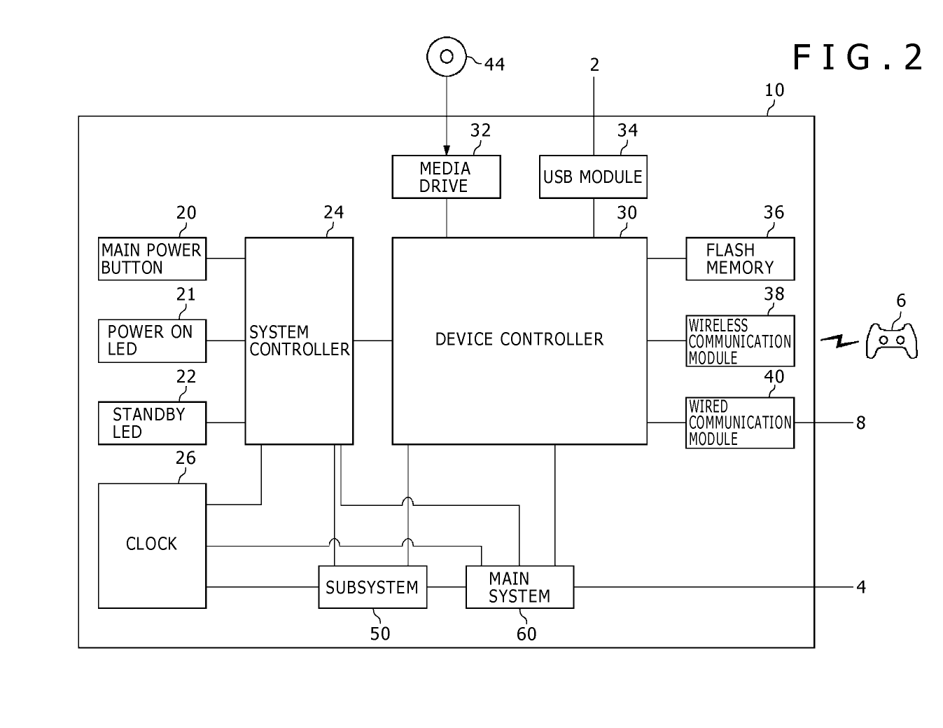

FIG. 2 is a functional block diagram of the information processing device 10. The information processing device 10 is configured to include a main power button 20, a power ON LED 21, a standby LED 22, a system controller 24, a clock 26, a device controller 30, a media drive 32, a USB module 34, a flash memory 36, a wireless communication module 38, a wired communication module 40, a subsystem 50, and a main system 60.

The main power button 20 is an input unit operated by the user for input. Mounted at the front of the enclosure of the information processing device 10, the main power button 20 is operated to turn on or off the supply of power to the main system 60 of the information processing device 10. In the description that follows, the main power supply being in the ON state means that the main system 60 is in an active state; the main power supply being in the OFF state means that the main system 60 is in a standby state. The power ON LED 21 glows when the main power button 20 is switched on. The standby LED 22 glows when the main power button 20 is switched off.

The system controller 24 detects whether the user has pressed the main power button 20. If the main power button 20 is pressed when the main power supply is in the OFF state, the system controller 24 acquires the pressing operation as an “ON instruction.” On the other hand, if the main power button 20 is pressed when the main power supply is in the ON state, the system controller 24 acquires the pressing operation as an “OFF instruction.” The ON/OFF control of the main power supply may be performed from the input device 6. If an appropriate button of the input device 6 (the button will be called the “HOME button” hereunder) is pressed when the main power supply is in the OFF state, the system controller 24 acquires the button operation as an “ON instruction.” On the other hand, if the HOME button is pressed when the main power supply is in the ON state, the system controller 24 acquires the button operation as an “OFF instruction.” With the information processing device 10 of this embodiment, if the main power supply is in the OFF state, that means the subsystem 50 is in an active state; if the main power supply is in the ON state, that means the main system 60 is in the active state.

Upon acquiring the ON instruction, the system controller 24 notifies the subsystem 50 in the active state of the result of the detection, turns off the standby LED 22, and turns on the power-ON LED 21. At this point, the subsystem 50 starts the main system 60 and goes into standby mode. On the other hand, upon acquiring the OFF instruction, the system controller 24 notifies the main system 60 in the active state of the result of the detection, turns off the power-ON LED 21, and turns on the standby LED 22. At this point, the main system 60 starts the subsystem 50 and goes into standby mode.

The clock 26 is a real-time clock that generates current date and time information, and feeds the generated information to the system controller 24, subsystem 50, and main system 60.

The device controller 30 is configured as an LSI (Large-Scale Integrated Circuit) that acts like the south bridge and transfers information between devices. As illustrated, the device controller 30 is connected with such devices as the system controller 24, media drive 32, USB module 34, flash memory 36, wireless communication module 38, wired communication module 40, subsystem 50, and main system 60. The device controller 30 controls data transfer timings by buffering the differences in electrical characteristics and data transfer rates between the devices.

The media drive 32 is a drive device that drives a loaded ROM medium 44 having application software such as games stored thereon so as to read programs and data therefrom. The ROM medium 44 is a read-only storage medium such as an optical disc, a magneto-optical disc, or a Blu-ray disc.

The USB module 34 is connected to external equipment with a USB cable. For example, the USB module 34 may be connected to the auxiliary storage device 2 that is a hard disk drive with a USB cable. The flash memory 36 is an auxiliary storage device making up an internal storage. The wireless communication module 38 may communicate wirelessly with the input device 6, for example, under communication protocol such as the Bluetooth (registered trademark) protocol or the IEEE 802.11 protocol. The input device 6 may be a game controller to be operated by the user for input. The wireless communication module 38 may also support the third-generation digital mobile phone system based on the IMT-2000 (International Mobile Telecommunication 200) standard stipulated by the ITU (International Telecommunication Union). The wired communication module 40 communicates with external equipment in wired fashion and may connect to the network 3 via the AP 8, for example.

The main system 60 includes the main CPU, a memory and a memory controller constituting a main storage device, a GPU (Graphics Processing Unit), and the like. These functions may be constituted as a system-on chip that is formed on a single chip. The main CPU has the function of executing applications installed in the auxiliary storage device 2.

The subsystem 50 includes the sub CPU, a memory and a memory controller constituting a main storage device, and the like but does not have the GPU. The number of circuit gates of the sub CPU is smaller than that of the main CPU, and the sub CPU operates with less power consumption than the main CPU. As mentioned above, the sub CPU is active while the main CPU is in the standby state. As such, the sub CPU has its processing functions limited so as to minimize power consumption. Incidentally, the sub CPU and memory may be formed on a separate chip.

The subsystem 50 has the information providing function and the download processing function, the information providing function being one which, upon receipt of the information providing request from the network server 5, accesses the auxiliary storage device 2 for requested information and transmits the relevant information to the network server 5. The download processing function of the subsystem 50 involves downloading content files from the content server 7 and storing the downloaded files into the auxiliary storage device 2. The main system 60 also has the information providing function and the download processing function. Depending on the main power supply being in the ON or OFF state, either of the subsystems carries out the information providing function and the download processing function.

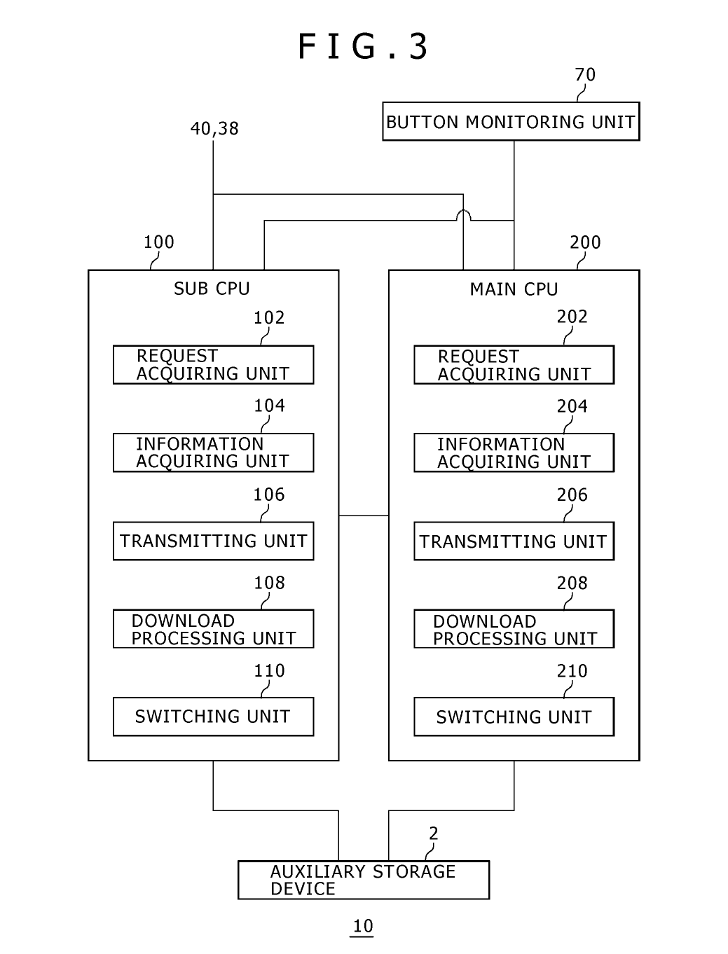

FIG. 3 is a functional block diagram of the information processing device 10, depicting the relations between the subsystem 50 and the main system 60 of this embodiment. The main system 60 has a main CPU 200 that operates when the main power supply is in the ON state, and the subsystem 50 has a sub CPU 100 that operates when the main power supply is in the OFF state. A button monitoring unit 70 monitors whether or not the main power button 20 is pressed or whether or not the HOME button of the input device 6 is pressed. That is, the button monitoring unit 70 monitors the switching of the main power supply between the ON state and the OFF state. The function of the button monitoring unit 70 is implemented by the system controller 24.

The sub CPU 100 includes a request acquiring unit 102, an information acquiring unit 104, a transmitting unit 106, a download processing unit 108, and a switching unit 110. The main CPU 200 includes a request acquiring unit 202, an information acquiring unit 204, a transmitting unit 206, a download processing unit 208, and a switching unit 210. In FIG. 3, the elements shown as the functional blocks for carrying out various processes may be formed by circuit blocks, memories, and other LSIs in terms of hardware, by programs loaded in memories, or the like in terms of software. Thus, it is to be understood by those skilled in the art that these functional blocks are implemented in diverse forms using only hardware, only software, or a combination of both, and these functional blocks are not limited thereto.

As mentioned above, in the information processing device 10 of this embodiment, the main CPU 200 is active when the main power supply is in the ON state, and the sub CPU 100 is active when the main power supply is in the OFF state. The main power supply being in the ON state refers to a time period in which the user is playing a game, for example. The main power supply being in the OFF state refers to, for example, a time period in which the user has stopped playing the game and turns off the main power supply until switching it on the next time. When either the main CPU 200 or the sub CPU 100 is in the active state, the information processing device 10 can continuously maintain the state of signing in to the network server 5.

In the information processing system 1, the network server 5 may transmit the information providing request in the script format to multiple information processing devices 10 connected to the network 3 for carrying out the statistical survey. The information providing request may involve requesting each information processing device 10 to send back necessary data to the network server 5 so as to examine how many pieces of game software have been installed or how many pieces of video content have been stored on average per information processing device 10, for example. The network server 5 may transmit the information providing request to thousands of information processing devices 10, for example.

To acquire useful results of processing with statistics generally requires random sampling. For example, with the information processing system described in the above-cited Patent Literature 1, if its main controller is in the standby state, the information processing device in question cannot receive the script from the network server. In that case, the demographics of the users signing in to the network (e.g., by age, gender, profession) can be biased depending on the hour at which the network server transmits the script, which makes random sampling difficult to achieve.

On the other hand, with the information processing system 1 of this embodiment, the sub CPU 100 is in operation even if the information processing device 10 has its main power supply turned off, so that the connection with the network 3 is maintained. Because either the sub CPU 100 or the main CPU 200 is in the active state, the information processing device 10 can always receive requests from the network server 5. This enables the network server 5 to transmit the information providing request to a suitable number of randomly selected information processing devices. What follows is a specific explanation of the processes performed by the information processing device 10.

### <When the Main Power Supply is On>

In the main CPU 200, the request acquiring unit 202 acquires the information providing request. The information providing request includes information designating the data to be collected by the network server 5 from the information processing device 10. The information acquiring unit 204 executes the information providing request in the script format and acquires the data included in the script from the auxiliary storage device 2. For example, the information providing request may involve requesting the transmission to the network server 5 of the details of the content, the number of game titles, and the number of videos retained in the auxiliary storage device 2. When the information acquiring unit 204 has acquired from the auxiliary storage device 2 the data designated by the information providing request, the transmitting unit 206 transmits the acquired data to the network server 5.

The information providing request may include information designating the data linked to the user accounts. The network server 5 may request to the user the information as to whether a specific game title has been started. For example, after advertisements of a particular game title were issued or after an event regarding a specific game title was held, the network server 5 may examine how many users have started the game title in question. For example, where the information processing device 10 is connected using the user account of user A, the network server 5 may request the transmission of the data about another user B registered with the information processing device 10 in question.

The content server 7 may transmit a content download instruction to the information processing device 10. The download instruction is received by the download processing unit 208. In turn, the download processing unit 208 downloads relevant content from the content server 7.

### <When the Main Power Supply is Off>

When the button monitoring unit 70 receives a power OFF instruction, the switching unit 210 sends a start instruction to the switching unit 110 of the sub CPU 100. When the sub CPU 100 is started, the supply of power to the main CPU 200 is stopped and the main CPU 200 goes into a standby state. In this state, the request acquiring unit 102 of the sub CPU 100 acquires the information providing request. The information acquiring unit 104 executes the information providing request in the script format and acquires the data included in the script from the auxiliary storage device 2. When the information acquiring unit 104 has acquired from the auxiliary storage device 2 the data designated by the information providing request, the transmitting unit 106 transmits the acquired data to the network server 5. Also, the download processing unit 108 in the sub CPU 100 may receive a download instruction from the content server 7. In turn, the download processing unit 108 downloads relevant content from the content server 7. When the button monitoring unit 70 receives a power ON instruction, the switching unit 110 sends a start instruction to the switching unit 210 of the main CPU 200. When the main CPU 200 is started, the supply of power to the sub CPU 100 is stopped and the sub CPU 100 goes into a standby state.

As described above, even when the main power supply remains off, an active sub CPU 100 can respond to the information providing request from the network server 5 in real time. The response is made possible because the information acquiring unit 104, like the information acquiring unit 204, can access the auxiliary storage device 2 to read data therefrom. Also, even when the main power supply remains off, the sub CPU 100 can respond to the download instruction in real time. This response is made possible because the download processing unit 108, like the download processing unit 208, can access the auxiliary storage device 2 to write data thereto.

In the information processing device 10 of this embodiment, either the sub CPU 100 or the main CPU 200 is in the active state, and only the active CPU gains access to the auxiliary storage device 2. Because arrangements are made not to let both CPUs access the auxiliary storage device 2 simultaneously, there is no need to perform complicated software coordination control for access purposes.

As mentioned above, the performance of the sub CPU 100 is lower than that of the main CPU 200. For this reason, if the request acquiring unit 102 receives the script while the main power supply remains off, the switching unit 110 may provide the script to the main CPU 200 the next time the main CPU 200 is started so that the information acquiring unit 204 may collect data and store the collected data into the auxiliary storage device 2. Alternatively, the request acquiring unit 102 may store the script into a predetermined storage area of the auxiliary storage device 2 so that when the main CPU 200 is started, the request acquiring unit 202 may reference the predetermined storage area to acquire the script therefrom. In this manner, the sub CPU 100 may let the main CPU 200 take over the process of data collection. The next time the request acquiring unit 102 receives the script, the request acquiring unit 102 may then read from the auxiliary storage device 2 the data collected and stored earlier by the information acquiring unit 204 and transmit the retrieved data to the network server 5.

Also, it might happen that the button monitoring unit 70 receives a power ON instruction during a download process performed by the download processing unit 108. In this case, the switching unit 110 starts the main CPU 200 as soon as possible and places the sub CPU 100 in the standby state. At this point, the download processing unit 208 in the main CPU 200 takes over the download process that was performed by the download processing unit 108 and downloads the data yet to be downloaded. Conversely, if the button monitoring unit 70 receives a power OFF instruction during a download process performed by the download processing unit 208, the switching unit 210 starts the sub CPU 100 as soon as possible and puts the main CPU 200 in the standby state. The download processing unit 108 continues to perform the download process carried out earlier by the download processing unit 208.

While the present invention has been described above in conjunction with a specific embodiment given as an example, it should be understood by those skilled in the art that the above-described composing elements and various processes may be combined in diverse ways and that such combinations and variations also fall within the scope of this invention.

It was shown in connection with the embodiment above that either the sub CPU 100 or the main CPU 200 alone is placed in the active state. Alternatively, the sub CPU 100 may be always kept in the active state because it consumes substantially low power. In this case, the information providing function and the download processing function of the information processing device 10 may be taken over by the sub CPU 100 only, while the main CPU 200 need not have these functions.

### REFERENCE SIGNS LIST

1 . . . Information processing system,
2 . . . Auxiliary storage device,
5 . . . Network server,
7 . . . Content server,
10 . . . Information processing device,
24 . . . System controller,
50 . . . Subsystem,
60 . . . Main system,
70 . . . Button monitoring unit,
100 . . . Sub CPU,
102 . . . Request acquiring unit,
104 . . . Information acquiring unit,
106 . . . Transmitting unit,
108 . . . Download processing unit,
110 . . . Switching unit,
200 . . . Main CPU,
202 . . . Request acquiring unit,
204 . . . Information acquiring unit,
206 . . . Transmitting unit,
208 . . . Download processing unit,
210 . . . Switching unit.

### INDUSTRIAL APPLICABILITY

The present invention may be applied to information processing devices such as game machines.

1. An information processing device either connected to or incorporating a storage device, the information processing device comprising:
a main CPU; and
a sub CPU;
the main CPU having a function of executing an application program whereas the sub CPU does not have the function of executing the application program,
wherein the sub CPU is in an active state while the main CPU is in a standby state, and
if the sub CPU receives a download instruction from a server while the main CPU is in the standby state, the sub CPU downloads an application-related file from the server and stores the file into the storage device, whereas the main CPU further receives the download instruction from the server if the main CPU is in the active state, and the main CPU further downloads the application-related file from the server and stores the file into the storage device.

2. An information processing device either connected to or incorporating a storage device, the information processing device comprising:
a main CPU; and
a sub CPU;
the main CPU having a function of executing an application program whereas the sub CPU does not have the function of executing the application program,
wherein the sub CPU is in an active state while the main CPU is in a standby state,
the main CPU, by use of a user account, signs in to a service provided by a server, and
the sub CPU maintains a state of signing in to the service provided by the server while the main CPU is in the standby state.

3. The information processing device according to claim 1, wherein the main CPU and the sub CPU are capable of reading data from the storage device.

4. The information processing device according to claim 1, wherein, while a main power supply of the information processing device remains off, the sub CPU is in the active state.

5. The information processing device according to claim 1, wherein,
upon receipt of a power ON instruction by a system controller, the sub CPU starts the main CPU and goes into the standby state, and
upon receipt of a power OFF instruction by the system controller, the main CPU starts the sub CPU and goes into the standby state.

6. The information processing device according to claim 1, wherein
the number of circuit gates of the sub CPU is smaller than that of the main CPU, and
the operating power consumption of the sub CPU is lower than that of the main CPU.

7. The information processing device according to claim 1, wherein, upon receipt of an information providing request from the server connected to a network, the sub CPU reads relevant information from the storage device and provides the information to the server.

8. The information processing device according to claim 1, wherein, upon receipt of an information providing request from the server connected to the network, the sub CPU starts the main CPU so that the main CPU acquires information in accordance with the information providing request and stores the information into the storage device.

9. The information processing device according to claim 2, wherein either the main CPU or the sub CPU signs in to the service in a manner maintaining the state of signing in continuously.
